(19) United States
(12) Patent Application Publication
(10) Pub. No.: US 2007/0115945 A1
(43) Pub. Date: May 24, 2007

(54) Communication protocol and method for operating a volp communication with additional data transmission

(75) Inventors: Raymond Gass, Bolsenheim (FR); Francois Pinier, Strasbourg (FR)

Correspondence Address: SUGHRUE MION, PLLC, 2100 PENNSYLVANIA AVENUE, N.W., SUITE 800, WASHINGTON, DC, 20037, US

(73) Assignee: Alcatel

(21) Appl. No.: 10/564,162

(22) PCT Filed: Aug. 18, 2003
(86) PCT No.: PCT/EP03/09118

§ 371 Date: Jan. 11, 2006

(51) Int. Cl. H04L 12/66

(52) U.S. Cl. 370/356

(57) ABSTRACT

The present invention concerns a communication protocol suitable for bi-directional VoIP communication with media streams including audio and/or video data, and based on a real-time transport protocol (RTP) as described in IETF RFC 1889, wherein packets mainly comprised of a header part and a payload part are exchanged between at least two users, thus forming a RTP channel, wherein at least one sub-channel is embedded within the RTP channel, said sub-channel being adapted to carry command, signaling and/or information data.

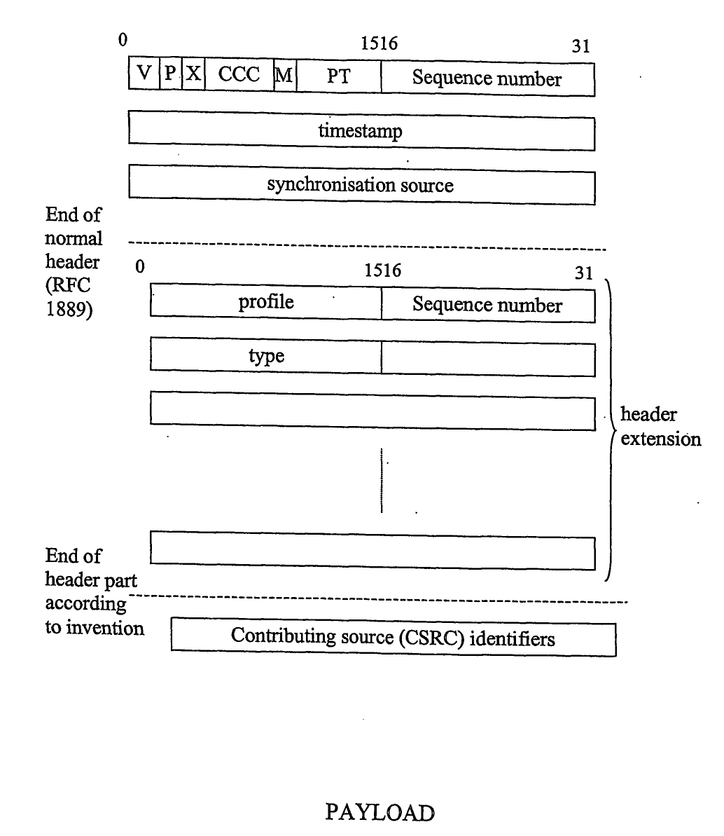

### TECHNICAL FIELD

The present invention is related to the field of the telecommunications, in particular in connection with Voice over Internet (VoIP) applications. The invention is based on a priority application PCT/EP03/09118 which is hereby incorporated by reference.

### BACKGROUND OF THE INVENTION

Nowadays, the real-time transport protocols using RTP channels as described in IETF RFC 1889, such as for example the protocols known as H.323, Session Initiation Protocol (SIP) or H.248/Megaco, only consider call-related information exchanges between terminating points.

Indeed, these protocols consider signaling between communications terminals only for call set up and evolution. Once the RTP communication channel is established, there is no possibility to transmit additional data, i.e. data other than the audio and/or video data forming the payload of the exchanged streams.

When considering the foregoing context, one must differentiate the two planes involved in such communications, namely the signaling plane and the user plane.

In the signaling plane, data is exchanges between signaling gateways using the afore mentioned protocols (H.323, SIP, . . . ) in order to configure the communication or session and to make it evolve if wanted or needed (invite another user, cut the communication, . . . ).

In the user plane, data is exchanged between media gateways over a RTP channel, the useful data being the payload.

Nowadays, no possibility is provided to allow transmission of additional media related data over said RTP channel, which for example could allow to modify the use of the media.

One must point out that the H.323 protocol provides a specific H.320 channel for exchanging such additional data. Nevertheless, using a proper channel for such purposes seems excessive and too resources consuming.

Furthermore, it must also be noticed that current IP networks do not provide means for inband end-to-end signaling.

### SUMMARY OF THE INVENTION

The main aim of the present invention is to fill the lack expressed before and to provide a simple solution allowing user-to-user additional data exchange during communications over IP networks.

Therefore, the present invention concerns first a communication protocol suitable for bi-directional VoIP communication with media streams including audio and/or video data, and based on a real-time transport protocol (RTP) as described in IETF RFC 1889, wherein packets mainly comprised of a header part and a payload part are exchanged between at least two users, thus forming a RTP channel, characterised in that at least one sub-channel is embedded within the RTP channel, said sub-channel being adapted to carry command, signaling and/or information data.

Preferably, the header part of each packet comprises at least one extension bit in a predetermined place, whereby allowing to provide one or several additional fields in the header or in a header extension of said packets to carry said command, signaling and/or information data.

The present invention also encompasses a method for operating a bi-directional VoIP communication over an IP network, based on a real-time transport protocol (RTP) as described for example in IETF RFC 1889, wherein media streams including audio and/or video data are exchanged, over a RTP channel, between at least two users, in the form of packets mainly comprised of a header part and a payload, characterised in that additional command, signaling and/or information data is transmitted through at least one sub-channel embedded within the RTP channel and available in both transmission directions.

As indicated before, additional fields are provided in the header part or in a header extension of the transmitted packets, in particular by setting at least one extension bit.

Thus, bi-directional user-to-user exchanges of information during a normal or a multimedia communication is made possible by creating sub-channels in a RTP channel to carry other types of data than said multimedia data.

For example, several kinds of sub-channels are possible:
command sub-channel
signaling sub-channel
information sub-channel.

Advantageously, the bi-directional VoIP communication is operated on the basis of the protocol as described before.

### BRIEF DESCRIPTION OF THE DRAWINGS

A preferred structure of an RTP packet incorporating the additional fields proposed by the invention, is schematically shown on the enclosed figure.

### DETAILED DESCRIPTION OF THE INVENTION

Thus, as can be seen from said figure, providing additional field(s) to carry said additional signaling data for transmission between users consists, in relation to the IETF RFC 1899 protocol features and for each transmitted packet, in setting the marker bit M and the extension bit X, in coding the payload type bits PT with the information of the user to user signals and in providing a header extension following the normal RTP header and comprising a profile indication field, a length indication field, a signaling type indication field and several bytes for receiving the additional data to be carried, the number of bytes corresponding to the value of the content of the length indication field.

When carrying out the method of the invention, the communication terminal of the user on the reception side analyses, upon receipt of a RTP packet, the header, in particular at least one extension bit, of the received packet and takes into account the command, signaling and/or information data contained in the additional fields of the said header or header extension.

The invention will now be described further on in a non limitative way and in relation to specific examples.

As exposed before, the main purpose of the invention is to introduce some additional information in media streams carried over a RTP channel. During bi-directional VoIP communication, media streams including either audio or video information or both are sent through a RTP channel fully described in the IETF RFC 1889 document.

Current RTP channels convey only media streams with few additional information like timestamps and sequence numbers.

The present invention proposes a new scheme of this RTP channel basically built on its current description by adding signaling messages on both paths of the bi-directional communication.

To add information in the RTP channel, it is necessary to extend the field of information to be carried. This is done by adding a new element in the header indicated by an extension bit. This extension bit enables to create new fields in the header to multiply considerably the possibilities of the RTP channel.

At reception of such a RTP packet, the receiving terminal analyses the header and reacts accordingly in taking into account the information contained in the sub-channel.

By way of the two following examples of two possible scenarii of communications between two users A and B, the practical advantages of the invention will become apparent.

As a first example, a VoIP call between A and B is considered:
A and B are talking and A asks B to spell a particular word,
B could choose either to spell it vocally or to write it on the keyboard of this own terminal then to send to A, via an information sub-channel, by activating a command on his terminal,
at reception, the terminal of user A analyses the header and then display the information on the screen/display.

As a second example, a multimedia communication (voice +video) between A and B is considered:
A and B are talking and use each their own motorized camera to show document and/or objects,
A presents an object in the field of the camera connected to his terminal,
B activates on his own terminal the joystick for zooming and/or modifying the angle of view,
the commands are transmitted via the existing RTP channel (either voice or video channel) from terminal B to terminal/camera A on an embedded sub-channel,
at reception, the terminal of user A analyses the header and then forwards the command to the camera.

The present invention is, of course, not limited to the preferred embodiment described and represented herein, changes can be made or equivalents used without departing from the scope of the invention.

1. A communication method, having a protocol suitable for bi-directional Voice over Internet Protocol (VoIP) communications with media streams including audio and/or video data, and based on a real-time transport protocol (RTP) in Internet Engineering Task Force (IETF) Request for Comments (RFC) 1889, the method comprising:
exchanging packets comprised of a header part and a payload part between at least two users to form a RTP channel; and
providing at least one sub-channel, which is embedded within the RTP channel, to carry command, signaling and/or information data.

2. The communication method according to claim 1, wherein the header part of each packet comprises at least one extension bit in a predetermined place to provide one or several additional fields in the header or in a header extension of said packets, to carry said command, signaling and/or information data.

3. A method for operating a bi-directional Voice over Internet Protocol (VoIP) communication over an Internet Protocol (IP) network, based on a real-time transport protocol (RTP) in Internet Engineering Task Force (IETF) Request For Comments (RFC) 1889, the method comprising:
exchanging media streams including audio and/or video data, over a RTP channel, between at least two users, in the form of packets comprised of a header part and a payload,
wherein additional command, signaling and/or information data is transmitted in both transmission directions through at least one sub-channel embedded within the RTP channel.

4. The method according to claim 3, wherein:
the header of each transmitted packet comprises at least one extension bit in a predetermined place, and
one or several additional fields provided in the header or in a header extension of said packets carry said command, signaling and/or information data.

5. The method according to claim 4, wherein:
providing additional field to carry said additional signaling data for transmission between users, for each transmitted packet, comprises setting the marker bit and the extension bit coding the payload type bits (PT) with the information of the user to user signals, and providing a header extension following the normal RTP header,
the additional fields comprise a profile indication field, a length indication field, a signaling type indication field and several bytes for receiving the additional data to be carried, and
the number of bytes correspond to the value of the content of the length indication field.

6. (canceled)

7. A method according to claim 4, wherein, upon reception of a RTP packet, the method further comprises analyzing the at least one extension bit in the header of the received packet, by a communication terminal of the user on the reception side, to take into account the command, signaling and/or information data contained in the additional fields of said header or header extension.

8. A multimedia telecommunication terminal adapted to perform a bi-directional Voice over Internet Protocol (VoIP) communication based on a real-time transport protocol (RTP) in Internet Engineering Task Force (IETF) Request For Comments (RFC) 1889, said terminal comprises:
means for exchanging media streams including audio and/or video data, over a RTP channel, between at least two users, in the form of packets comprised of a header part and a payload,
wherein additional command, signaling and/or information data is transmitted in both transmission directions through at least one sub-channel embedded within the RTP channel.
